(19) United States
(12) Patent Application Publication
(10) Pub. No.: US 2013/0334820 A1
(43) Pub. Date: Dec. 19, 2013

(54) ENERGY SUPPLY DEVICE FOR A VEHICLE AND SELF-PROPELLED WORK TRAIN

(71) Applicant: ZF Friedrichshafen AG, Friedrichshafen (DE)

(72) Inventors: Manuel GOETZ, Ravensburg (DE); Axel Michael MUELLER, Friedrichshafen (DE); Torsten HERING, Uberlingen (DE); Lothar LASZIG, Lubeck (DE)

(73) Assignee: ZF Friedrichshafen AG, Friedrichshafen (DE)

(21) Appl. No.: 13/899,820

(22) Filed: May 22, 2013

(30) Foreign Application Priority Data
Jun. 15, 2012 (DE) 10 2012 210 078.4

(51) Int. Cl. B60L 1/00; B60L 11/00

(52) U.S. Cl. CPC B60L 1/006; B60L 11/00
USPC 290/45; 307/9.1

(57) ABSTRACT

An energy supply device (110) for a vehicle (100) which comprises a first electrical energy supply circuit (115) that is designed to connect a source (130,140) of electrical energy to at least one first consumer (145) which is inherently part of the vehicle. At least one electrical interface (165), coupled to the first energy supply circuit (115), is provided for a second electrical energy supply circuit (120) for supplying electrical energy to at least one second consumer (160) external of the vehicle. In this case, the interface (165) for the vehicle-external second consumer (160) of the second electrical energy supply circuit (120) is separated from the first electrical energy supply circuit (115) by a potential separator device (170) and, in particular, a galvanic potential separator device.

This application claims priority from German patent application serial no. 10 2012 210 078.4 filed Jun. 15, 2012.

### FIELD OF THE INVENTION

The present invention relates to an energy supply device for a vehicle and to a self-propelled work train.

### BACKGROUND OF THE INVENTION

Equipment with a mobile generator unit that is integrated in the drive-train or that can be mounted and driven on the vehicle can be integrated in a vehicle both structurally and functionally in an optimal manner, and compared with portable external generator units with their own internal combustion engine (so-termed Gensets), can therefore be made more powerful and space-saving, without the cost and complexity of auxiliary appliances. In such cases an E-machine (i.e. electric machine) is included in the integrated generator unit or mounted on the vehicle, which is driven by way of a mechanical, rotary power take-off from the drive-train (directly from the crankshaft or via a power take-off shaft). Often, such generator systems serve not only for the supply of electric power to electric (auxiliary) drives on the vehicle itself, but can also supply electrical energy (for example by way of a plug socket) to external electric drives or electricity consumers. A distinction is then often made between stationary external drives or consumers (machine tools etc.) and external drives or consumers supplied while driving. An example of supplying a stationary external consumer would be the powering of an electric circular saw or a stationary ventilation fan in livestock farming. An example of an external consumer operated while driving would be the powering of electric drives on an agricultural trailer, for example an electric pump drive on a crop sprayer. In such cases the drive task to be performed can consist not only of providing electric power for the drives on the trailer, but also the actuation of electric drives on the trailer, and in the latter case an inverter for the electric (three-phase or alternating current) drive can also be integrated in the generator unit together with the inverter of the generator. Of course, a generator system thus integrated in the vehicle, with a suitable inverter and motorized drive, is also suitable for operation in a hybrid system as an auxiliary drive and supplied by way of an electrical energy accumulator.

Present-day generator systems consist of an overall electric power supply. This power supply system is monitored by an insulation monitoring unit. Large and complex systems involve long lead lengths and numerous components. This can result in insulation measurement errors and false alarms during operation. A further disadvantage of this supply system structure is that in the event of a fault the entire system is affected. Thus, emergency operation is no longer possible.

The document DE 10 2007 024 645 A1 discloses a device for the electric supply of an agricultural working vehicle and/or a trailer that can be coupled to the working vehicle.

### SUMMARY OF THE INVENTION

Against this background the present invention provides an improved energy supply device for a vehicle and an improved self-propelled work train.

The present invention provides an energy supply device for a vehicle, with a first electric energy supply circuit designed to connect a source of electrical energy to at least one first consumer which is inherently part of the vehicle itself, whereas at least one electric interface coupled to the first energy supply circuit is provided for a second energy supply circuit for the supply of electrical energy to at least one second consumer separate from the vehicle.

According to the invention, the interface for the second consumer separate from the vehicle is or can be separated from the first electrical energy supply circuit by a potential separator device. In particular, by means of the potential separator device, an electric potential of the second electrical energy supply circuit is or can be separated from an electric potential of the first electrical energy supply circuit.

The vehicle can be in particular a self-propelled working machine. A self-propelled working machine is a working machine with its own independent drive, i.e. it comprises a motor of its own, in particular permanently built in, for propelling the machine. For example, a self-propelled working machine can be a tractor or rather an agricultural tractor, a harvester thresher, a timber harvester, a forwarder, a wheel loader, a grader, a bagger, a mobile crane or the like. Thus, in particular the invention is suitable for a self-propelled working machine used on land or in forests or in the building industry. Such machines are increasingly often electrified by replacing hydraulic consumers with electric consumers, since electric consumers have better mechanical-electronic control characteristics and greater overall efficiency than a hydraulic consumer. A consumer or further consumer can be understood to mean an electric device that takes up electric power and carries out a desired function corresponding thereto. The function can be in particular a mechanical movement carried out by the consumer. Such a function can also be the operation of a data processing unit which performs a control and/or monitoring task. A consumer which is inherently part of the vehicle is in particular a consumer permanently built into the vehicle, which is normally not changed or can be changed only for maintenance purposes, for example an electric drive motor for propelling the vehicle, an electric cooling fan, electric lighting of the vehicle, etc. In contrast, the second consumer separate from the vehicle is in particular a consumer of an attached unit which can be temporarily coupled to the vehicle or coupled in exchange for other attached units, for example an electric pump drive of a crop sprayer or an electric drive of a hay making machine or seed sowing machine, an electric vibrator, a shredder, a cable drum, etc. This means that the consumer or the attached unit equipped therewith is deliberately designed to be easily exchanged. For example the attached unit can be easily coupled to and decoupled from the vehicle by a semitrailer coupling, an adjustable drawbar or drawbar rail, a front loader, etc. Thus, the second consumer separate from the vehicle can be understood to mean a consumer which is not an original part of the vehicle or necessary for the operation of the vehicle, and specifically which can be exchanged for other consumers or attached units separate from the vehicle, which in particular serve some other purpose. The electric interface is in particular a plug device, for example a plug-and-socket arrangement for the simple and quick connection of the second energy supply circuit to the first energy supply circuit, such as a plug socket.

An energy supply circuit can be understood to mean an electric power supply system or partial system which enables an electricity consumer to be supplied with electrical energy. The electrical energy can come from a wide variety of sources, such as an electrical energy storage device, (for example an accumulator) or even a generator. For example, the electrical energy supplied to the consumer by one of the energy supply circuits can come from a vehicle battery or a dynamo operated as an electric machine or generator. A potential separator device can in particular be understood to mean a device which enables a potential separation of the two energy supply circuits and at the same time allows electrical energy to be transferred between the two circuits. Thus, the potential separator device is in particular a galvanic potential separator device. In this way the first energy supply network is or can be separated from the second energy supply network. However, a transfer of electric power from the first to the second energy supply system and/or vice-versa is still always enabled.

The present invention is based on the recognition that the operation of an energy supply system (particularly in the application context of vehicles or utility vehicles) can be stabilized substantially if the system is separated into a plurality of partial systems. In that way perturbances, for example caused by an appliance plugged into or coupled to the energy supply system (i.e. the energy supply device) externally, can only affect a limited part or partial section of the energy supply system. The potential separation of the two coupled system parts or circuits of the energy supply system ensures that in particularthe system-stability-impairing effects on other parts of the energy supply system can largely be suppressed, whereas a power or energy flow between the part-systems or energy supply circuits of the energy supply device can nevertheless still take place. In this way the security of the energy supply system as a whole against breakdown can be increased. In particular in accordance with the invention the power supply system is divided into a partial system serving to operate the vehicle and another partial system serving to operate an attached unit. Faults in one of the part-systems, for example a short-circuit, do not therefore affect the other part-system or only have a small effect on it. Accordingly, for example, if a fault occurs in the second energy supply circuit, in an extreme case the attached unit with the second consumer separate from the vehicle may no longer be capable of being used, but the vehicle itself, with the first energy supply circuit can still be used, and vice-versa.

In an embodiment of the present invention the first and/or the second energy supply circuit can be made as a direct-voltage intermediate circuit. Such a design of the present invention has the advantage that by way of a direct-voltage intermediate circuit of this type very high powers can be transferred with a very low breakdown incidence. To this or these energy supply circuit(s) it is then technically very simple for example to connect one or more transformer circuits to transform the direct voltage for use in the consumer(s) connected to the energy supply circuit concerned.

In another favorable embodiment of the present invention, the potential separator device is in the form of a direct voltage/direct voltage transformer (DC/DC transformer). Such a design of the present invention has the advantage that an inexpensive structural element is used for making the potential separator device.

Also conceivable is an embodiment of the present invention in which the first and/or second energy supply circuit is made as an insulated power supply system. An insulated system means a system in which two energy-carrying conductors are electrically insulated in the first place from one another and in the second place also from other contact points. Thus, for example, in an insulated system no return lead via a common electrical ground is used for completing a current circuit. Such a design of the present invention has the advantage that the safety of those operating the vehicle is increased, since in the event of a first breakdown there can be no personal risk due to electric shock.

According to a further embodiment of the present invention, at least one insulation monitoring device can be provided for monitoring an electrical resistance, specifically an insulation resistance, between at least one conductor of the first energy supply circuit and a ground terminal of the energy supply device, in particular between the active leads of the first energy supply circuit and a ground terminal of the energy supply device. Alternatively or in addition, a further insulation monitoring device can be provided for monitoring an electrical resistance, specifically an insulation resistance, between at least one conductor of the second energy supply circuit and the ground terminal of the energy supply device, in particular between the active leads of the second energy supply circuit and the ground terminal of the energy supply device. Such a design of the present invention has the advantage of increasing still more the security against breakdown, since by virtue of the insulation monitoring unit possible defects in the electrical insulation of conductors in one of the energy supply systems consisting of an energy supply circuit can be promptly identified and repaired, or the energy supply circuit concerned, in which a fault has been detected, can be taken out of service in order as much as possible to prevent the risk of breakdown of the energy supply system as a whole.

In a particularly advantageous embodiment of the present invention, the first energy supply circuit is designed to enable exclusively the supply of electrical energy to stationary consumers fixed in or on the vehicle. Such an embodiment of the present invention has the advantage that the coupling of external electricity consumers separate from the vehicle, which are not fixedly (i.e. permanently and statically) connected with the vehicle, takes place exclusively by way of the interface of the second energy supply circuit. In this way, the action of the potential separator results in a protective effect which limits or completely avoids a transfer of perturbances from the external appliance separate from the vehicle to the first energy supply. If now only stationary consumers operating on or in the vehicle are supplied with energy exclusively via the first energy supply circuit, at least a high stability of the first energy supply can be guaranteed since the consumers connected to that circuit are known and in most cases not very susceptible to perturbances.

In another embodiment of the present invention at least one further electrical interface coupled to the first energy supply can be provided for a third energy supply circuit for supplying electrical energy to at least one additional consumer separate from the vehicle, such that the further electrical interface for the third electrical energy supply circuit supplying the additional consumer separate from the vehicle is or can be separated by means of a further potential separator device from a potential of the first energy supply circuit. Such a design of the present invention has the advantage of increasing the security of the energy supply device against breakdown, since now, during use, at least three consumers to be supplied by the energy supply device can be connected to different energy supply circuits. This can also avoid the situation that, for example, two consumers both external to the vehicle are connected to the second energy supply circuit and one of those two consumers connected to the second energy supply circuit develops a fault that results in failure of the entire second energy supply circuit, so that even the still functional consumer can no longer be operated. If the different consumers are connected to different energy supply circuits each of them coupled to the first energy supply circuit by a potential separator device of its own, such a failure of functional appliances or consumers can largely be avoided so the stability against perturbances or failure is again increased.

Also conceivable is an embodiment of the present invention in which the electrical interface for the second energy supply circuit and/or the electrical interface for the third energy supply circuit comprises at least one voltage transformer, which is designed to transform a voltage for the second or third energy supply circuit to a transformed voltage and to supply the transformed voltage to the second or to the additional consumer separate from the vehicle. Alternatively or in addition, in another embodiment of the present invention the first energy supply circuit can also comprise at least one other voltage transformer designed to transform a voltage of the first energy supply circuit into a transformed voltage and to supply the transformed voltage to the first consumer. Such an embodiment of the present invention has the advantage that using the voltage transformer adds a further instance of a perturbance-compensating mechanism, which increases the security against failure. In the event of a fault the voltage transformer can be switched off and thus the defective component, for example the consumer separate from the vehicle, can simply be electrically cut off from the power supply system or the first energy supply circuit.

In another embodiment of the present invention the first energy supply circuit can also comprise as its energy source an electric accumulator and/or an electric machine, in particular such that the electric machine is built in permanently (i.e. stationary) in a vehicle and/or is or can be coupled to a driveshaft of the vehicle.

In a further embodiment of the present invention a potential monitoring unit can also be provided, which is designed to monitor an electric potential in potential equalization lines between components of the first and second, or between components of the first and third, or between components of the second and third, or between components of all the energy supply circuits and to emit an error message if the potential monitoring unit detects an interruption of the potential equalization lines. Such an embodiment of the present invention has the advantage of enabling the early recognition of errors that occur, so that the repair of defects or faulty components can be initiated promptly in order to ensure the security of the energy supply device against breakdown.

The invention also relates to a self-propelled work train comprising a self-propelled working machine with the above-described energy supply device and the first consumer that is inherent to the vehicle, this being in particular a working machine for use in agriculture, forestry or in the building industry. The work train also comprises an electrically operated attached appliance that is coupled to the self-propelled working machine and can be exchanged with the vehicle-external second consumer, this being in particular an attached appliance used in agriculture, forestry or on building sites. The first consumer serves in particular for operating the self-propelled working machine and the second consumer for operating the attacked appliance coupled thereto. Electrical perturbances in the respective energy supply circuits thereby do not spread between these, or only less seriously so, such that down-times of the attached appliance and the working machine are reduced. Correspondingly, the attached appliance comprises the second and if necessary further energy supply circuits, which are electrically connected to the first energy supply circuit by way of the interface or further interfaces and the respective potential separator devices.

### BRIEF DESCRIPTION OF THE DRAWINGS

An example of the invention is described in more detail below with reference to the attached drawings, which show:

FIG. 1: A block circuit diagram of an energy supply device of a vehicle, which is an embodiment of the present invention;

FIG. 2: A block circuit diagram, of a possible potential monitoring system for use in an example embodiment of the present invention;

FIG. 3: A sequence diagram of a method for operating an energy supply device in an example embodiment of the present invention; and

FIG. 4: A sequence diagram of a method for producing an energy supply device according to an example embodiment of the present invention.

### DETAILED DESCRIPTION OF THE PREFERRED EMBODIMENTS

In the following description of preferred example embodiments of the present invention the same or similar indexes are used to denote elements shown in the various figures whose function is similar, so that there is no need to describe these elements repeatedly.

One aspect of the present invention is to indicate a protection concept for an electrical system on a vehicle for the supply of internal and/or external drives or electricity consumers, which comprises protection against electric shock, but which as much as possible enables the monitoring, including an adoption of protective measures, of the vehicle carrying the current-producing generator, hereinafter just called the vehicle. By dividing a large power-supply system into a number of small individual systems, the availability and susceptibility to breakdown can be reduced. For example, the insulation monitoring then takes place in each part-system separately. With the new system structure an extension to additional part-systems is possible without influencing the existing power-supply systems. By separating the systems the part-system containing the generator or source of electrical energy (such as the energy accumulator) is additionally protected. Thus, the use of consumers whose properties are unknown has no influence on the availability of the generator system (i.e. the first energy supply circuit).

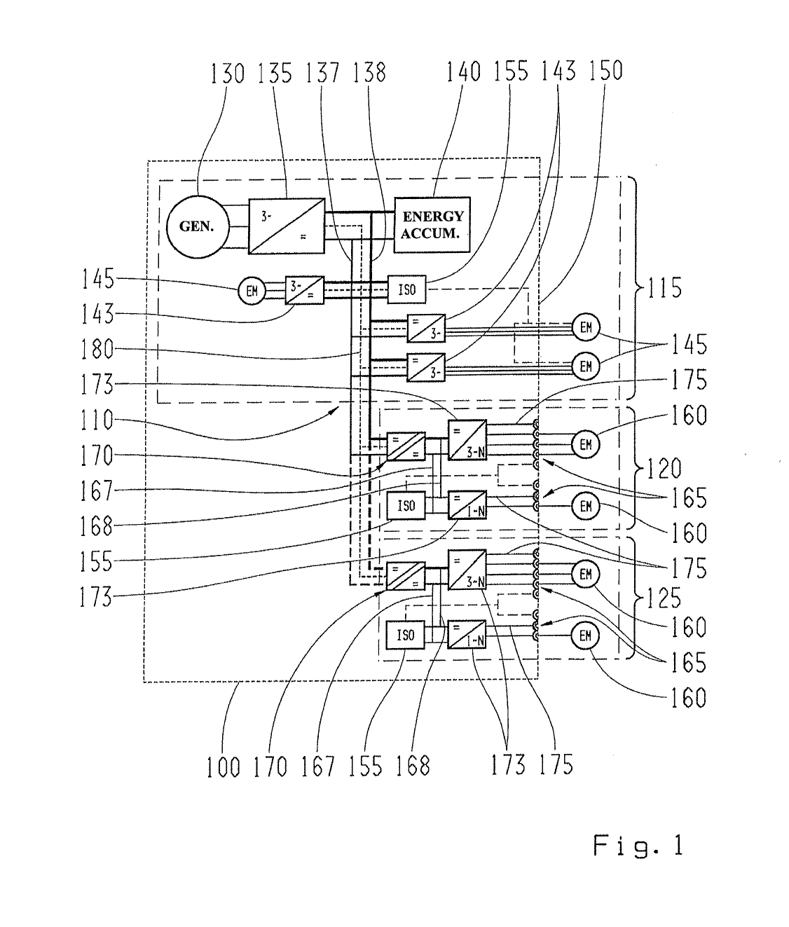

FIG. 1 shows a block circuit diagram of an energy supply device 110 of a vehicle 100 which is an example embodiment of the present invention. In this case FIG. 1 can be understood as a synopsis of an electrical system designed as an IT system (IT system=insulated-earth-system=insulated system) with potential separation for the electric part-system (for example, for an attached appliance), and which has insulation monitoring for the vehicle. The energy supply device 110 shown in FIG. 1 comprises a first energy supply circuit 115, a second energy supply circuit 120 and a third (i.e. further) energy supply circuit 125. The first energy supply circuit 115 is for example formed by the electrical power-supply system of the vehicle 100 which, however, in modern hybrid vehicles can in particular also be in the form of a high-voltage system with a voltage such as 700 V. The second energy supply circuit 120 can be designed as an electric part-system and the third, further energy supply circuit 125 as a further, optional part-system.

The first energy supply circuit 115 comprises for example as its generator 130 a permanently energized synchronous machine, connected as a dynamo or other electric machine to a driveshaft of an internal combustion engine (not shown, for the sake of simplicity) for driving the vehicle 100. In addition or alternatively to the internal combustion engine the generator, operated as an electric motor, can also be used if necessary for driving the vehicle 100. The electrical energy supplied by the generator 130, which is delivered in the form of a three-phase alternating current or alternating voltage, is transformed by a generator voltage transformer 135 into a direct voltage with a high voltage, for example 300 V to 700 V, for vehicle applications. This high direct voltage is applied between a first conductor rail 137 and a second conductor rail 138 of the first energy supply circuit 115, for example such that the first conductor rail 137 is a high-voltage positive pole and the second conductor rail 138 is a high-voltage negative pole. In addition, an electricity storage device 140 such as an accumulator is optionally connected to the first 137 and second 138 conductor rails, which enables intermediate storage of the energy supplied by the generator 130. Moreover, to the first 137 and second 138 conductor rails are connected one or more consumer voltage transformer(s) 143, which are designed for example to transform the direct voltage applied between the conductor rails 137 and 138 into a (three-phase) alternating voltage required by a respective consumer 145 connected to a consumer voltage transformer 143. The consumers 145 can be in the form of electric machines (EM) and may require different voltage levels, and in that case the consumer voltage transformers 143 associated respectively with the corresponding consumers 145 produce the necessary different voltages by transforming the direct voltage applied between the conductor rails 137 and 138. At the same time it is also possible to operate not just consumers 145 carried and/or arranged statically in the vehicle as electric auxiliary aggregates (such as an electrically operated engine cooling device, an air-conditioning unit, lighting, etc.) Rather, it is also conceivable that the conductor rails 137 and 138 of the first energy supply circuit 115 can be used for connecting one or more electric machines external to the first energy supply circuit 115 as auxiliary aggregates, in particular by way of the voltage transformers 143. This therefore provides a possible means for connecting such consumers 145 via an interface (not shown) that bridges a separation plane 150 to such external electric appliances, in order to be able to supply them with electrical energy.

The two conductor rails that form the high-voltage positive pole 137 and the high-voltage negative pole 138 are preferably designed as an insulated power-supply system, i.e. each of the two conductor rails 137 and 138 is electrically insulated from all other potential-carrying elements (and thus also from a vehicle ground). In this way the greatest possible security against perturbances and at the same time the lowest possible danger to people due to the high voltage between the two conductor rails 137 and 138 can be ensured. In order also to monitor the defect-free electrical insulation in particular of consumers 145 outside the vehicle 100 that can be connected thereto, an insulation monitoring unit 155 is provided, which detects any electrical insulation deficiency, for example by measuring a resistance between conductors of the consumer 145 and an electrical ground and indicating an insulation deficit if the value measured is too low.

To now produce an energy supply device 110 as defect-free as possible, a second energy supply circuit 120 is provided, which is designed to supply second consumers 160 separate from the vehicle which are in particular arranged outside the vehicle 100 and are supplied by way of an electrical interface 165. In the second energy supply circuit 120 two conductor lines are provided, which form the high-voltage positive pole 167 and the high-voltage negative pole 168. These poles 167 and 168 are coupled to the conductor lines 137 and 138 of the first energy supply circuit 110 by way of a potential separator device 170, which for example forms a direct voltage/direct voltage transfer unit (DC/DC transfer unit) or a DC/DC transformer. For example, the conductor lines 167 and 168 can be separated galvanically from the conductor rails 137 and 138. Depending on the voltages required by the various second consumers 160, different further consumer voltage transformers 173 can also be provided, which for example transform a direct voltage between the conductor lines 167 and 168 into a three-phase alternating voltage with a neutral line 175 (N) or into a one-phase alternating voltage with a neutral line 175 (N). By using the neutral line 175 (N) a higher protection level at the interface 165 of the second energy supply circuit 120 to which the second consumers 160 separate from the vehicle are connected, can be ensured. Furthermore, this enables the connection of consumers that function exclusively in combination with a neutral line, whereby the flexibility of the interface 165 is increased. At the same time, in the second energy supply circuit 120 which in this case forms an electrical part-system in the vehicle 100, an insulation monitoring device 155 is also provided which is designed analogously to the insulation monitoring device 155 of the first energy supply circuit and monitors the defect-free insulation of the conductors leading to the second consumers 160.

In addition the third energy supply circuit 125 at least can still be provided, which in FIG. 1 is designed in the same way as the second energy supply circuit 120 and is also coupled to the conductor rails forming the high-voltage positive pole 137 and the high-voltage negative pole 138 of the first energy supply circuit 115. In this case again a (further) potential separator device 170 is provided, which separates a potential in the conductor lines 167 and 168 of the third energy supply circuit 125 from a potential in the conductor rails of the first energy supply circuit 115. Further energy supply circuits analogous to the second or third energy supply circuits 120, 125 for the respective supply of other, additional vehicle-external consumers are conceivable.

By using the second (and/or third and/or further) energy supply circuits 120 (or 125) for supplying vehicle-external second consumers 160 with electrical energy, the security of the energy supply device 110 against malfunction or failure is increased since, for example in the event of a fault such as a short-circuit in one or more of the second consumers 160 a reaction of the fault is only to be feared as far back as the potential separator device 170. So if such a fault results in the failure of a part-section of the electrical energy distribution network provided by the energy supply device 110, the failure is limited to that part-system 120 or 125 without, for example, the first energy supply circuit 115 also being affected by the fault in the second consumer 160. For example, if a short-circuit occurs in an electric attached appliance such as an electric circular saw, which is connected to the electric interface 165 of a tractor as the vehicle 100, an engine cooler connected as an electric auxiliary aggregate 145 to the first energy supply circuit 115 can nevertheless continue being operated even if the second energy supply circuit 120 forming the part-system has failed. Likewise, an additional consumer 160 separate from the vehicle connected to the third energy supply circuit 125, such as a front lifting device on the vehicle 100, can still be operated.

Furthermore a potential equalization line 180 is provided, to which all the units connected to the high-voltage positive pole 137 and the high-voltage negative pole 138 (and to the electrical energy accumulator 140) are advantageously connected. This potential equalization line 180 ensures the possibility of monitoring the potential connections between the electrical components and ground in the at least two energy supply circuits 115 and 120, so that for example any damage of the insulation of the potential equalization line 180 can be detected and a corresponding fault signal can be emitted.

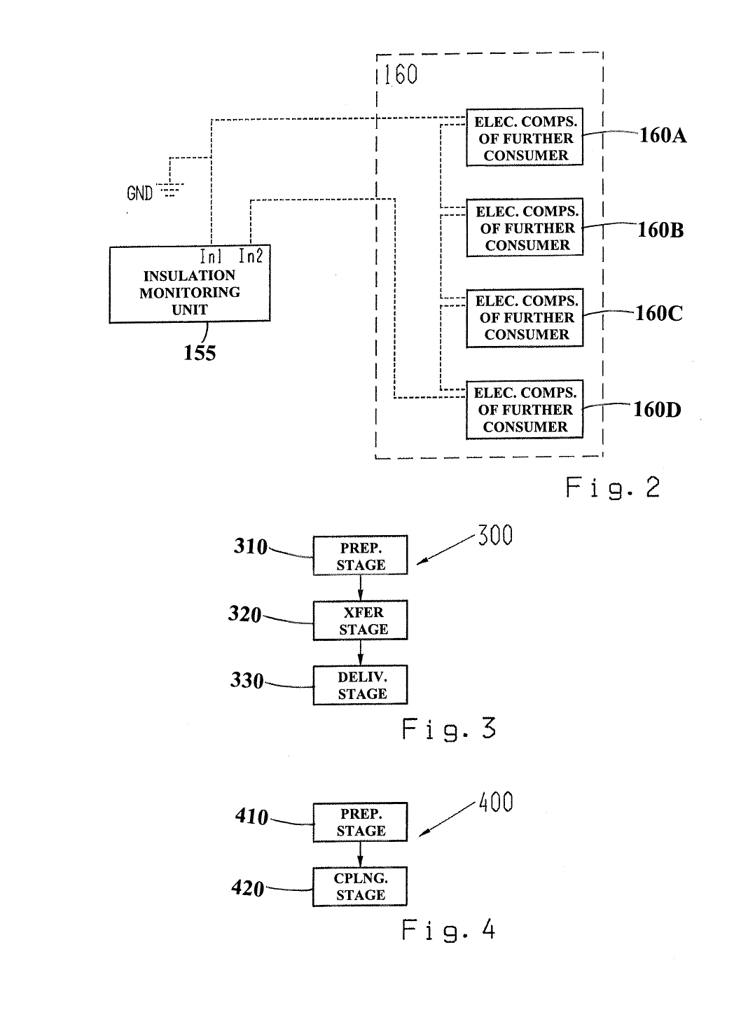

For example such monitoring of the potential equalization line 180 of electric components on an attached appliance constituting a vehicle-external second consumer 160 can be carried out in accordance with FIG. 2. FIG. 2 shows a block circuit diagram of a possible potential monitoring method for use in an example embodiment of the present invention. Thus, FIG. 2 illustrates an example of a monitoring system for the potential equalization line of electrical components, for example on an attached appliance. In this example case individual components 160a-d of the electric consumer 160 are connected, for example by the potential equalization line 180, in a ring circuit to a ground GND, whereas a corresponding monitoring unit 155 (such as the insulation monitoring unit present in the energy supply circuits 115 and 120) can detect a break in the ring circuit and emit a corresponding fault signal.

In summary it should be noted that a vehicle, with a current-producing electric machine (generator), can be equipped for supplying electricity to consumers accommodated on the vehicle and/or external electricity consumers. According to one aspect of the present invention, the current-producing electric machine (generator) can even be built into the vehicle, for example on its frame or on a holding device (such as a power hoist on the tractor). In that case the electrical systems on the vehicle and on the vehicle-external consumers, if applicable including existing receiving mobile appliances (hereinafter referred to as attached appliances) can be in the form of insulated system(s) (IT systems). The voltage and current can be transferred between the electric power-supply systems of the vehicle and the attached appliance. During this the supply of electricity to possible consumers on the attached appliance can also take place, combined with or without potential separation (for example directly from the first energy supply circuit). It is particularly advantageous, however, for electricity to be supplied to all vehicle-external electricity consumers on attached appliances, including also stationary appliances such as a fixed hay-making fan or a fixed irrigation pump, by way of a potential separator device. In that case such a potential separator device can be located on the vehicle before an attached appliance rectifier. The potential separator device can also be integrated in a DC/DC transformer or in some other unit equipped with appropriate potential separating means. This provides particularly good protection against disorders that may occur (information projection by information from an ISO monitor 155), and insulation monitoring of electrical components can be provided, which are fed from the vehicle system but are fitted on the attached appliance and are monitored from the vehicle together with the insulation monitoring of all the components on the vehicle that belong to the vehicle system. Furthermore, the potential separation can produce two separate IT systems monitored by separate insulation monitors. This separate structure has advantages when several distributed consumers on the attached appliance have to be monitored. In that case of course, care should be taken that the housings of all the components on the attached appliance are connected by potential equalization lines. It is also conceivable that the insulation monitoring of potential-separated external consumers on the attached appliance is carried out from the vehicle, but in that case the insulation monitoring unit (i.e. the ISO monitor 155) is arranged after the potential separation from the vehicle system (as shown in FIG. 1). In one example embodiment active potential monitoring can also be used, which ensures that the potential connections (potential equalization lines) between the electrical components in the two IT systems are monitored so that a break of the potential equalization line can be detected, as illustrated schematically in FIG. 2. In a further example embodiment the concept presented here can be extended to a plurality of (partial) systems on the vehicle and the attached appliance. Again, by virtue of the division into separately monitored part-systems, if a malfunction occurs only one part-system is affected. This increases the reliability and availability.

FIG. 3 shows a sequence diagram for a method 300 for operating an energy supply device according to an example embodiment of the present invention. The method 300 is designed for operating an energy supply device for a vehicle with a first electrical energy supply circuit, which connects a source of electrical energy to at least one first consumer, whereas at least one second electrical energy supply circuit coupled to the first energy supply circuit is provided for supplying electrical energy to at least one second consumer, in such manner that an electric potential of the second electrical energy supply circuit is or can be separated by a potential separator device from an electric potential of the first electrical energy supply circuit. The method 300 comprises a step 310 in which electrical energy is supplied to the first energy supply circuit. Furthermore, the method 300 comprises a step 320 in which electrical energy is transferred from the first energy supply circuit by way of the potential separator device to the second energy supply circuit, and a step 330 in which electrical energy is given up by the second energy supply circuit to the at least one second consumer. In particular, the first consumer is inherently part of the vehicle while the second consumer is specifically not part of the vehicle.

FIG. 4 shows a sequence diagram of a method 400 for producing an energy supply device according to an example embodiment of the present invention. The method 400 for producing an energy supply device for a vehicle comprises a step 410 in which a first electrical energy supply circuit is provided, which is designed to connect a source of energy to at least one first consumer that is inherently part of the vehicle, and in which at least one second electrical energy supply circuit is provided for supplying electrical energy to at least one second consumer that is not part of the vehicle. Finally, the method 400 comprises a step 420 in which the first and second energy supply circuits are coupled using a potential separator device, which is designed to separate a potential of the second electrical energy supply circuit from a potential of the first electrical energy supply circuit.

The example embodiments described and shown in the figures are only chosen as examples. Different example embodiments can be combined with one another completely or in relation to individual features. In addition an example embodiment can be supplemented by features of another example embodiment. Furthermore, process steps according to the invention can be repeated or implemented in a sequence other than that described.

If an example embodiment contains an “and/or” link between a first feature and a second feature, it can be interpreted to mean that the example embodiment in one version involves both the first and the second feature, while in another version it involves only the first, or only the second feature.

### INDEXES

100 Vehicle
110 Energy supply device
115 First energy supply circuit
120 Second energy supply circuit
125 Third energy supply circuit
130 Generator
135 Generator voltage transformer
137 First conductor rail, high-voltage positive pole
138 Second conductor rail, high-voltage negative pole
140 Electrical energy accumulator
143 Consumer voltage transformer
145 First consumer
150 Separation plane to external consumers
155 Insulation monitoring unit
160 Second consumer, additional consumers
160a-d Electric components of the (further) consumer(s)
165 Interface to a further consumer
167 First conductor lead, high-voltage positive pole
168 Second conductor lead, high-voltage negative pole
170 Potential separator unit
173 Further consumer voltage transformer
175 Neutral line
300 Method for operating an energy supply device
310 Preparation stage
320 Transfer stage
330 Delivery stage
400 Method for producing an energy supply device
410 Preparation stage
420 Coupling stage

1-12. (canceled)

13. An energy supply device (110) for a vehicle (100), the energy supply device comprising:
a first electrical energy supply circuit (115) designed to connect a source (130, 140) of electrical energy to at least one first consumer (145) that is inherently part of the vehicle,
at least one electrical interface (165) coupled to the first electrical energy supply circuit (115) being provided for a second electrical energy supply circuit (120) for supplying electrical energy to at least one vehicle-external second consumer (160), which is not part of the vehicle, and is an exchangeable electrically operated attached appliance, and
a first galvanic potential separator device (170) separating the electrical interface (165), for the vehicle-external second consumer (160) of the second electrical energy supply circuit (120), from the first electrical energy supply circuit (115).

14. The energy supply device (110) according to claim 13, wherein at least one of the first and the second electrical energy supply circuits (115, 120) is a direct-voltage intermediate circuit.

15. The energy supply device (110) according to claim 13, wherein the first potential separator device (170) is a DC/DC transformer.

16. The energy supply device (110) according to claim 13, wherein at least one of the first and the second electrical energy supply circuits (115, 120) is an insulated power-supply system.

17. The energy supply device (110) according to claim 13, wherein at least one of an insulation monitoring device (155) monitors electrical resistance between at least one conductor (137, 138), of the first electrical energy supply circuit (115), and a ground terminal of the energy supply device (110), and a further insulation monitoring device (155) monitors electrical resistance between at least one conductor (137, 138), of the second electrical energy supply circuit (120), and the ground terminal of the energy supply device (110).

18. The energy supply device (110) according to claim 13, wherein the first electrical energy supply circuit (115) is exclusively designed to enable supply of electrical energy to the at least one first consumer (145) either fixed stationary in or on the vehicle (100).

19. The energy supply device (110) according to claim 13, wherein at least one further electrical interface (165), for a third electrical energy supply circuit (125), is coupled to the first electrical energy supply circuit (115) for supplying electrical energy to at least one vehicle-external additional consumer (160) such that the further electrical interface (165), for the vehicle-external additional consumer (160) of the third electrical energy supply circuit (125), is separated from the first electrical energy supply circuit (115) by a further galvanic potential separator device (170).

20. The energy supply device (110) according to claim 19, wherein at least one of the electrical interface (165), for the second electrical energy supply circuit (120), and the electrical interface (165), for the third electrical energy supply circuit (125), comprises at least one voltage transformer (173) which respectively transforms a voltage for the second or the third electrical energy supply circuit s(125) and supplies the transformed voltage to the vehicle-external additional consumer (160).

21. The energy supply device (110) according to claim 13, wherein the first electrical energy supply circuit (115) comprises at least one other voltage transformer (143), which transforms a voltage of the first electrical energy supply circuit (115) into a transformed voltage and supplies the transformed voltage to the at least one first (145).

22. The energy supply device (110) according to claim 13, wherein the source (130, 140) of electrical energy for the first electrical energy supply circuit (115) comprises at least one of an electricity accumulator (140) and an electric machine (130).

23. The energy supply device (110) according to claim 13, wherein the source (130, 140) of electrical energy for the first electrical energy supply circuit (115) comprises an electric machine (130), and the electric machine (130) is at least one of permanently built into the vehicle (100) and couplable to a driveshaft of the vehicle (100).

24. The energy supply device (110) according to claim 13, wherein a potential monitoring unit (155) monitors an electric potential in at least one potential equalization line (180) between components of at least two of the first, the second and the third electrical energy supply circuits (115, 120, 125), and emits an error message if the potential monitoring unit (155) detects a break in the at least one potential equalization line (180).

25. A self-propelled work train in combination with an energy supply device (110),
the self-propelled work train is one of an agriculture, a forestry and a building industry self-propelled working machine and the energy supply device comprising a first electrical energy supply circuit (115) designed to connect a source (130, 140) of electrical energy to at least one vehicle-inherent first consumer (145) that is inherently part of the self-propelled working machine,
at least one electrical interface (165), coupled to the first electrical energy supply circuit (115), being provided for a second electrical energy supply circuit (120) for supplying electrical energy to at least one vehicle-external second consumer (160) which is not part of the self-propelled working machine, and being an exchangeable electrically operated attached agriculture, forestry, building industry appliance, and
the electrical interface (165) for the vehicle-external second consumer (160) of the second electrical energy supply circuit (120) being separated from the first electrical energy supply circuit (115) by a galvanic potential separator device (170).

26. An energy supply device (110) for a self-propelled working vehicle, the energy supply device comprising:
an electrical energy source being electrically connected, via a first electrical energy supply circuit (115), to at least one first consumer (145) of the working vehicle, the at least one first consumer being an inherent, built in electrical component of the working vehicle;
a second electrical energy supply circuit (120) being electrically connected to at least one second consumer (160), the at least one second consumer being an electrically operated independent component that is optionally attachable to the working vehicle;
the second electrical energy supply circuit being electrically connected, via at least one electrical interface (165), to the first energy supply circuit (115) to supply the at least one second consumer with electrical energy from the electrical energy source; and
a galvanic potential separator device separating the at least one electrical interface (165) of the second electrical energy supply circuit from the first electrical energy supply circuit (115).
